(19) United States
(12) Patent Application Publication
(10) Pub. No.: US 2015/0317405 A1
(43) Pub. Date: Nov. 5, 2015

(54) Web Page Variation

(71) Applicant: THUNDERHEAD LIMITED, Hertfordshire (GB)

(72) Inventor: Glen MANCHESTER, Elstree, Hertfordshire (GB)

(21) Appl. No.: 14/652,000

(22) PCT Filed: Dec. 20, 2013
(86) PCT No.: PCT/GB2013/053400

§ 371 Date: Jun. 12, 2015

(30) Foreign Application Priority Data
Dec. 13, 2012 (GB) 1222514.0

(51) Int. Cl. G06F 17/30; G06F 17/22

(52) U.S. Cl. CPC G06F 17/30896; G06F 17/2247

(57) ABSTRACT

A computer implemented method for defining, at a web browser, an element of a web page for variation, the method comprising the steps of: the browser providing an element selection facility for a user to select an element for variation as a variable element; in response to an element selection, the browser storing an identifier of the variable element; the browser rendering a variant of the web page by adding at least one additional element to the web page so as to render the web page with a variation of the variable element.

### FIELD OF THE INVENTION

The present invention relates to the variation of web pages. In particular, it relates to defining elements of web pages for variation.

### BACKGROUND OF THE INVENTION

Web page variation is the provision of a plurality of variants of a web page. Such variation can be employed for a variety of reasons, such as in response to regulatory or legal requirements, to improve web page accessibility, to measure the effectiveness of web page variants for marketing purposes or for the tailoring of a web page to reflect a particular user or group of users.

The preparation of potentially large numbers of variants of a web page can be time consuming and requires a technical understanding of the construction, modification and provision of web pages and web services. Those engaged in the variation of such web pages, such as marketing professionals, are not always competent to undertake such technical development tasks.

Some solutions are available that allow a user to generate a variant of a web page by visually editing the document object model (DOM) of the web page using software tools. For example, tools such as Optimizely (www.optimizely.com) provide for the definition of variants of a web page by allowing a user to define modifications to the web page visually. The modifications are stored on a server computer system for subsequent recall. Variations of the web page can be viewed in a preview mode after, or as part of, the editing process. Ultimately, the web page variants are deployed for production use whereby they are available to all users.

In order for services such as Optimizely to apply modifications to a web page when it is rendered in a web browser it is necessary to insert a script reference into the web page hosted at a web server. An executable script indicated by the script reference works with stored modification information to effect modifications to the web page when it is rendered. In order for services such as Optimizely to effect modifications to a web page a user is required to be willing and able to modify the server copy of the web page. This applies in both a preview and production mode of rendering.

Where a user is unable or not prepared to modify the server copy of the web page to include a script reference, services are unable to effect modification of a web page. For example, during the editing process, a user may wish to preview a web page variant without inserting a script reference into the hosted version of a web page. Alternatively, a user may wish to prepare a web page variant where the user does not have access to the web server on which the web page is hosted. In these cases, it is necessary for a proxy to interrupt the transmission of the web page between the web server and the browser at a user's client device. A proxy can be adapted to insert a script reference such that, when rendered by the web browser, an executable script indicated by the script references is operable to effect modifications to the web page when it is rendered.

The use of a proxy introduces a level of indirection between the web server and the browser. This indirection can interfere with the operation of some web pages elements or features. For example, some secure web pages such as financial services web pages cannot operate through a proxy. Similarly, web pages having dynamic or variable content which require a connection to a web server or other server may not function or render correctly when accessed through, and modified by, a proxy. For example, a web page including dynamically generated navigation links or controls, scripts, native or rich embeddings may not function or render correctly. Similarly, web pages having a complex structure such as many or complex controls or elements, complex layouts or scripted features may not function or render correctly.

It would therefore be advantageous to provide a mechanism for defining and rendering, at a web browser, an element of a web page for variation without the aforementioned disadvantages.

### SUMMARY OF THE INVENTION

The present invention accordingly provides, in a first aspect, a computer implemented method for defining, at a web browser, an element of a web page for variation, the method comprising the steps of: the browser providing an element selection facility for a user to select an element for variation as a variable element; in response to an element selection, the browser storing an identifier of the variable element; the browser rendering a variant of the web page by adding at least one additional element to the web page so as to render the web page with a variation of the variable element.

Preferably the variable element identifier is stored at a server computer system.

Preferably the at least one additional element is a reference to an executable script stored at a server computer system and being suitable for execution by the web browser.

Preferably the script is operable to perform a method including the steps of: retrieving at least one modification instruction from the server computer system, wherein the at least one modification instruction defines a modification of the variable element; and modifying the variable element in accordance with the one or more modification instructions so as to render a variant of the variable element.

Preferably the one or more modification instructions are determined by a modification generator based on a characterisation of a user of the web browser.

Preferably a modification of the variable element includes one or more of: an addition of a resource to the variable element; a removal of a resource from the variable element; a specification of a size of the variable element; a specification of a size of a resource associated with the variable element; a specification of a location of the variable element; a specification of a location of a resource associated with the variable element; a specification of one or more resources for rendering with the variable element; a visibility state of the variable element; and specifying one or more attributes of the variable element.

Preferably the addition of a resource, removal of a resource and specification of one or more resources include references to at least one resource stored at the server computer system.

Preferably the steps of identifying, providing, storing and rendering are undertaken by a browser extension.

Preferably the method further comprises the steps of: the browser accepting a user input specifying a modification to the selected element of the web page; and storing the specified modification as a modification instruction at a server computer system.

The present invention accordingly provides, in a second aspect, a web page variation definition apparatus for defining, at a web browser, an element of a web page for variation, the apparatus comprising: an element selector for a user to select an element for variation as a variable element; a storer for storing an identifier of the variable element; a renderer for rendering a variant of the web page by adding at least one additional element to the web page so as to render the web page with a variation of the variable element.

Preferably the at least one additional element is a reference to a component at a server computer system, the component comprising: a retriever for retrieving at least one modification instruction from the server computer system, wherein the at least one modification instruction defines a modification of the variable element; and a modifier for modifying the variable element in accordance with the one or more modification instructions so as to render a variant of the variable element.

Preferably the one or more modification instructions are determined by a modification generator based on a characterisation of a user of the web browser.

Preferably the apparatus further comprises: a user input acceptor for accepting a user input specifying a modification to the selected element of the web page; and a further storer for storing the specified modification as a modification instruction at a server computer system.

The present invention accordingly provides, in a fourth aspect, a computer program element comprising computer program code to, when loaded into a computer system and executed thereon, cause the computer to perform the steps of a method as described above.

### BRIEF DESCRIPTION OF THE DRAWINGS

A preferred embodiment of the present invention is described below in more detail, by way of example only, with reference to the accompanying drawings, in which:

FIG. 1 is a block diagram of a computer system suitable for the operation of embodiments of the present invention;

FIG. 2 is a component diagram illustrating an arrangement of a web page variation system in accordance with a preferred embodiment of the present invention;

FIG. 3 is a detailed component diagram illustrating the arrangement of FIG. 2 in accordance with a preferred embodiment of the present invention;

FIG. 4 is a flowchart of a method of the functional component of FIG. 3 in accordance with a preferred embodiment of the present invention;

FIG. 5 is a state diagram illustrating a preferred embodiment of the present invention in operation for defining an element of a web page for variation;

FIG. 6a is a state diagram illustrating one embodiment of the present invention in operation for defining a modification instruction for a web page;

FIG. 6b is a component diagram illustrating a modification instruction generator in accordance with an alternative embodiment of the present invention;

FIG. 7 is a state diagram illustrating a preferred embodiment of the present invention in operation for previewing a variant of a web page; and

FIG. 8 is a component diagram illustrating an arrangement of a web browser in accordance with an exemplary embodiment of the present invention in use.

### DETAILED DESCRIPTION OF THE PREFERRED EMBODIMENTS

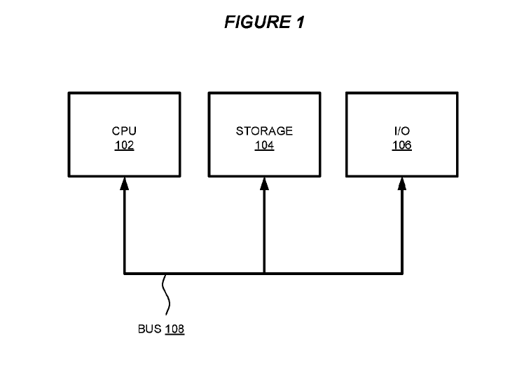

FIG. 1 is a block diagram of a computer system suitable for the operation of embodiments of the present invention. A central processor unit (CPU) 102 is communicatively connected to a storage 104 and an input/output (I/O) interface 106 via a data bus 108. The storage 104 can be any read/write storage device such as a random access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

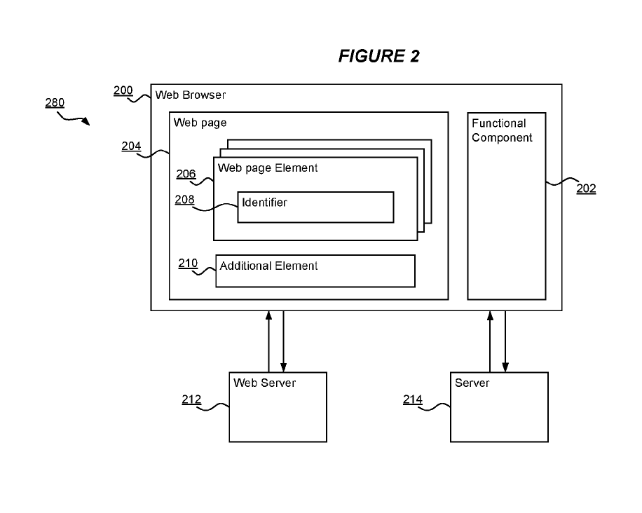

FIG. 2 is a component diagram illustrating an arrangement of a web page variation system 280 in accordance with a preferred embodiment of the present invention. The web page variation system 280 is an arrangement of software, hardware or software and hardware elements including a web browser 200. The web browser 200 is a software and/or hardware component operable to receive web page information such as HTML or augmented HTML web page documents from a web server 212. Example web browsers include Internet Explorer™ provided by Microsoft™ Corporation (Internet Explorer and Microsoft are Trademarks or Registered Trademarks of Microsoft Corporation); Chrome™ provided by Google™ (Chrome and Google are Trademarks or Registered Trademarks of Google); Firefox™ provided by Mozilla™ (Firefox and Mozilla are Trademarks or Registered Trademarks of Mozilla Inc.); Opera™ provided by Opera Software′ (Opera is a Trademark or Registered Trademark of Opera Software); Safari provided by Apple™ Inc. (Safari and Apple are Trademarks or Registered Trademarks of Apple Inc) or any other web browser as will be known to those skilled in the art.

The web server 212 is a hardware or software component in network communication with the web browser 200. The network communication is typically arranged such that the web server and the web browser are embodied as, or located on, separate devices although it will be apparent to those skilled in the art that such communication could be effected on a single device such as a single computing device.

In use, the web browser 200 receives web page documents such as web page 204 from the web server 212. Web page 204 is, for example, an HTML document including one or more web page elements 206. Each web page element 206 is an individual component of the web page 204 having an identifier 208 and attributes. For example, a web page defined in HTML can include elements such as: container elements (e.g. “DIV”); textual elements (e.g. “H1”, “SMALL”); image elements (e.g. “IMG”); anchor elements (e.g. “A”); as well as other elements such as user interface controls, dynamic elements, embedded media elements including audio or video, embedded software such as Java applets or native controls.

The web browser 200 includes a functional component 202 as a software or hardware component operable to provide various functions of the web browser 200 as will be described below. The functional component 202 is illustrated as an integrated part of the web browser 200 although those skilled in the art will appreciate that various functions provided by the functional component 202 could equally be provided by single or multiple separate functional components which may or may not constitute part of the web browser 200. For example, the functional component 202 can be embodied as one or more plugins or extensions to the web browser 200.

In use the functional component 202 is operable to provide an element selection facility to a user of the web browser 200 such that the user can select a web page element 206 for variation. A web page element 206 selected for variation is a variable element. Such selection can be achieved by visual means, such as a user interface selection mechanism, or by data entry means or any other suitable means for selecting a web page element 206. For example, the selection can be made by visually emphasising a selected one of the web page elements 206 so allowing a user to select a web page element 206. Alternatively, the selection can be made by listing the web page elements 206 and allowing a user to select a web page element 206 from the list. In a further alternative the web page 204 may be switched to a “selection” mode in which a user is able to indicate a web page element 206 by, for example, clicking or indicating on such element. It will be apparent to those skilled in the art that any number of mechanisms are suitable for a user to select a web page element 206.

The functional component 202 is further operable to store an identifier 208 of a selected web page element 206 at a server computer system 214. The server computer system 214 is a hardware or software component in network communication with the web browser 200 such that the browser 200, functional component 202 and any functional elements of the web page 204 are able to communicate with the server 214. The network communication is typically arranged such that the web server and the web browser are embodied as, or located on, separate devices although it will be apparent to those skilled in the art that such communication could be effected on a single device such as a single computing device. Such communication can include the transfer of operational instructions and associated data such that data can be stored at, and retrieved from, the server 214. It will also be apparent to those skilled in the art that, while the server 214 is illustrated as being separated from the web server 212, the server 214 may be collocated with the web server 212.

The identifier 208 of the variable element is stored at the server 214. In this way, one of the web page elements 206 is recorded for variation by the web page variation system 280. The functional component 202 is further operable to insert, inject or otherwise add an additional element 210 to the web page 204. The additional element 210 provides for the browser to render a variant of the web page 204 such that the web page 204 exhibits a variation of the variable element. In a preferred embodiment the additional element 210 is a reference to an executable script stored on the server 214 as will be described in detail below. Such an executable script in combination with the stored identifier of the variable element effects a variation of the variable element so as to effect a variation of the web page 204.

It will be apparent to those skilled in the art that a user may select multiple, many or numerous web page elements 206 for variation, so providing multiple variable elements, such that multiple elements 206 of a web page 204 are varied by the web page variation system 280.

Accordingly, a web page variation system 280 in accordance with the present invention is operable to effect the rendering of the web page 204 by the web browser 200 with a variation to a selected one of the web page elements 206 without the use of a proxy or other intermediary between the web server 212 and the web browser 200. Further, the web page variation system 280 effects a modification of the web page 204 without a need for a user to modify a server copy of the web page 204.

The removal of the need to modify a server copy of the web page 204 allows for the variation of the web page 204 in situations where a user is not willing or able to modify the server copy. For example, a user seeking to model variations to a web page 204 which is not accessible to the user, such as a web page 204 owned by a third party, is able to effect such modifications using embodiments of the present invention.

Further, the absence of any intermediate proxy provides for the effective variation of the web page 204 in situations where a proxy would otherwise interfere with the desirable operation of the web page 204. For example, where the web page 204 is a secure web page, such as may be provided by financial services organisations, the security of the web page 204 can be assured without interference of a proxy while web page variation can still be effected. Similarly, where web page 204 has dynamic or variable content which requires a connection to the web server 212 or some other server, variation of the web page 204 can be effected without interference of a proxy. Yet further, the interference of a proxy is also avoided where the web page 204 includes dynamically populated fields or controls, scripts, native or rich embeddings, complex structure such as complex controls or elements, complex layouts or scripted features.

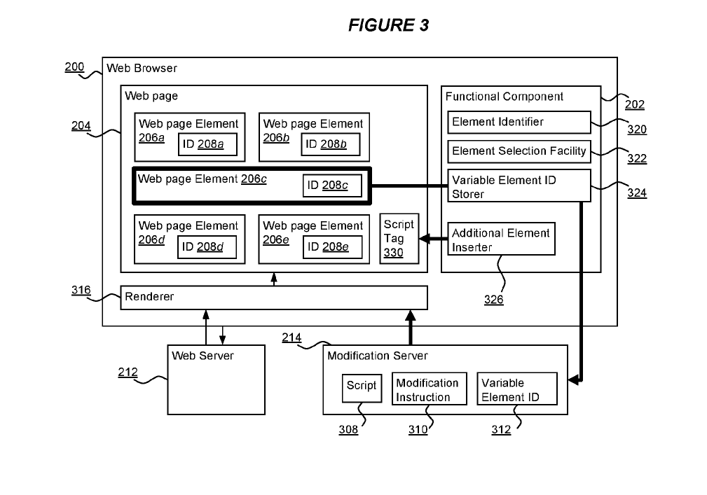

FIG. 3 is a detailed component diagram illustrating the arrangement of FIG. 2 in accordance with a preferred embodiment of the present invention. Many of the features of FIG. 3 are identical to those described above with respect to FIG. 2 and these will not be repeated here. The web page 204 of FIG. 3 is elaborated to illustrate five discrete web page elements 206a to 206e. Each of the web page elements 206a to 206e includes an identifier 208a to 208e. Additionally, the web browser 200 of FIG. 3 includes a renderer 316 as a software or hardware component operable to render a web page served by the web server 212. Such rendering includes, inter alia, receiving and interpreting a definition of the web page 204, such as a HTML definition, and rendering the web page for presentation to a user. Such presentation may be on a screen or any other suitable user output device.

The functional component 202 of FIG. 3 includes sub-components as element identifier 320, element selection facility 322, variable element identifier storer 324, and additional element inserter 326. The sub-components 320 to 326 are illustrated as integral parts of a single functional component 202 although it will be appreciated by those skilled in the art that the sub-components 320 to 326 can be implemented as separate functional components 202 of the web browser 200, such as separate web browser extensions or plugins.

The element identifier 320 is a software and/or hardware component operable to identify web page elements 206a to 206e within the web page 204 received from the web server 212. For example, the element identifier 320 can be operable to parse a document definition language data structure, such as an HTML document, to identify web page elements 206a to 206e. In one embodiment, the element identifier 320 is an integral part of the web browser 200, such as part of web page parsing and rendering functionality of the web browser 200.

The element selection facility 322 is a software and/or hardware component operable to provide means for a user of the web browser 200 to select one of the web page elements 206a to 206e as a variable element 206c for variation. In the example of FIG. 3 a heavy emphasis box is used to allow a user to select web page element 206c as a variable element.

The variable element identifier storer 324 is a hardware or software component for storing an identifier 208c of the variable element 206c. The identifier 208c is stored at the modification server 214 as variable element identifier 312.

The additional element inserter 326 is a software and/or hardware component operable to insert, inject or otherwise add an additional element 210 to the web page 204. In a preferred embodiment the additional element inserter 326 inserts a script tag 330 to the web page 204. The script tag 330 is a reference to an executable script 308 stored on the server 214 such as JavaScript™ (JavaScript is a registered trademark of Oracle Inc). An example of script tag 330 is:
<script src=“URL”></script>

Where “URL” is a uniform resource locator for the executable script 308. The uniform resource locator refers to a location of the executable script 308 on the server 214 such that, on loading of the web page 204, the web browser 200 accesses the script 308 on the server 214 and executes the script 308. In a preferred embodiment, the executable script 308 is operable to retrieve at least one modification instruction 310 for the variable element 206c. The modification instruction 310 defines a modification to the variable element 206c to be applied by the executable script 308 executed by the web browser 200, as is described in detail below. Further, the executable script 308 is operable to modify the variable element 206c in accordance with the modification instruction 310.

The modification instruction 310 can define the addition, removal or specification of one or more web page elements or resources associated, or to be associated, with the variable element 206c, such as the addition of text, image(s), media, web page or user interface control(s), video(s), sound(s), animation(s), new web page element(s), dynamic web page element(s) or other web page resource. The modification instruction 310 can specify a size, orientation or other attribute(s) or characteristic(s) of the variable element 206c, such as dimensions along x and y axes, location or position on the web page 204, scaling, font, font size, orientation, direction, visibility or any other attribute or characteristic of the variable element 206c. The modification instruction 310 can specify a size, orientation or other attribute(s) or characteristic(s) of one or more resources associated the variable element 206c, such as dimensions along x and y axes, location or position on the web page 204, scaling, font, font size, orientation, direction, visibility or any other attribute or characteristic of such resources.

In a preferred embodiment, the modification instruction 310 is interpreted by the script 308 executing in the web browser 200. Thus, the script 308 preferably includes a modification instruction interpreter. Accordingly, the modification instruction 310 preferably takes a standardised form such that the script 308 is operable to interpret any modification instruction 310 conforming to such standard form. Such standardisation of modification instructions provides a decoupling between the script 308 and a component generating modification instructions, such component being described below. For example, the modification instruction 310 can take the general form:
[element identifier][mod type][mod attributes]

The “element identifier” field is an identifier 208 of a web page element 206 in the web page 204. The “mod type” field identifies a type of modification from a set of modification types. For example, classes of modification can be defined such as modifications relating to, inter alia: the addition of an element or resource; the deletion of an element or resource; the position of an element or resource on the web page; the size of an element or resource; or a visibility state of an element or resource. The “mod attributes” field defines attributes according to the modification type. For example, an instruction for setting a position of an element on the web page 204 may have attributes specifying a desired position.

It will be appreciated by those skilled in the art that such a form of modification instruction 310 is entirely exemplary and any form or structure of modification instruction 310 for defining a modification for a web page element 206 is suitable for use with embodiments of the present invention.

Once interpreted, the script 308 executes the modification instruction by effecting a modification of the variable element 206c so as to render a variant of the variable element and, accordingly, a variant of the web page 204. The script 308 can modify the variable element 206c with reference to a document object model (DOM) of the web page 204. For example, where the web page 204 is comprised of HTML, the DOM of the web page 204 will comprise addressable objects that can be modified by reference to web page element identifiers 208a to 208e. For example, an addressable object for a web page element can be obtained by JavaScript using the “getElementById” call, passing the element identifier 208 as a parameter. The resulting object reference returned by such a call can be used as a basis for invoking methods and modifying object attributes. For example, the “getAttribute” and “setAttribute” JavaScript calls can be used to obtain and set attribute states for a DOM object. In this way the script 308 executed by the browser 200 is operable to modify attributes of the variable element 206c.

In use, a user of the web browser 200 selects a web page element 206c as a variable element 206c using the element selection facility 322. The identifier 208c of the variable element 206c is stored at the modification server 214 and associated with a modification instruction 310. The user may select, opt or request to view the web page 204 rendered with variations. For example, the user may select a ‘preview’ or ‘review’ option. The additional element inserter 326 inserts, injects or otherwise adds the script tag 330 to the web page 204 and the renderer 316 renders the web page 204 in the browser 200. As part of rendering the web page 204 the executable script 308 referenced by the script tag 330 is executed by the browser 200. The executable script 308 retrieves and interprets the modification instruction 310 associated with the variable element 206c by reference to the variable element identifier 312 stored at the server 214. Once interpreted, the executable script 308 is operable to modify the variable element 206c to effect a variation to the variable element 206c and an according variation to the web page 204.

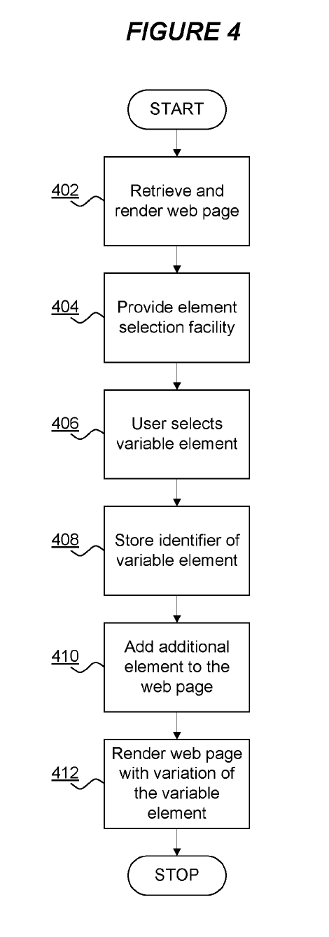

FIG. 4 is a flowchart of a method of the functional component 202 of FIG. 2 in accordance with a preferred embodiment of the present invention. Initially, at step 402, the functional component 202 retrieves the web page 204 from the web server 212 and renders the web page 204 using a renderer 316. Such rendering includes interpreting any web page specification language such as HTML that is comprised in the web page 204 and that defines one or more web page elements 206a to 206e. At step 404 the method provides an element selection facility 322 for a user to select a variable element 206c for variation. At step 406 the user selects the variable element 206c and at step 408 the variable element identifier storer 324 stores the variable element identifier at the server 214. At step 410, which may be prompted by a user, the additional element inserter 326 inserts, injects or otherwise adds an additional element 210 such as a script tag 330 to the web page 204. Finally, at step 412 the renderer 316 of the web browser 200 renders the web page 204 including the script tag 330. The rendering of the web page 204 results in the retrieval and execution of the script 308 resulting in a variation of the variable element 206c.

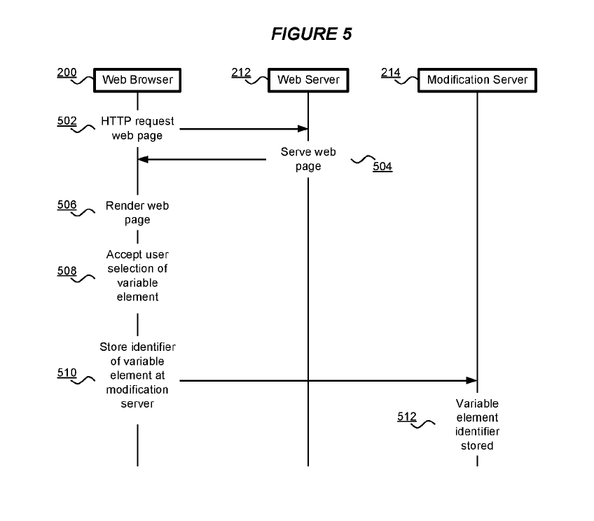

FIG. 5 is a state diagram illustrating a preferred embodiment of the present invention in operation for defining an element 206 of a web page 204 for variation. At step 502 the web browser requests the web page 204 from the web server 212. At step 504 the web server 212 communicates the web page 204 to the web browser 200. At step 506 the renderer 316 renders the web page 204. At step 508 the web browser 200 accepts a user's selection of a variable element 206c. At step 510 the web browser 200 communicates an identifier 208c of the variable element 206c to the modification server 214 where the identifier 208c is stored at step 512.

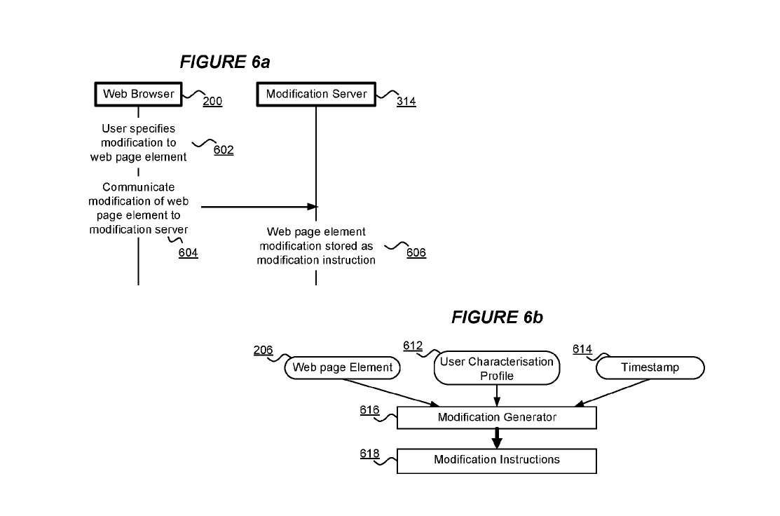

The definition of the modification instruction 310 will now be considered with reference to FIGS. 6a and 6b which present alternative or complementary techniques to the generation of the modification instruction. The description with reference to FIG. 6a relates to the generation of the modification instruction 310 by a user modifying one of the web page elements 206 to generate a modification instruction. The description with reference to FIG. 6b relates to the automatic generation of the modification instruction 310 by a modification generator 616.

FIG. 6a is a state diagram illustrating one embodiment of the present invention in operation for defining a modification instruction for a web page 204. At step 602 a user identifies a web page element 206 and specifies a modification to the web page element 206. For example, the web browser 200 can provide for the selection of a web page element 206 by entering a ‘selection’ mode of operation in which a user is able to select a web page element 206 for modification. Alternatively, the web browser 200 may supply a list of web page elements from which the user chooses an element for modification. Other possible approaches to web page element 206 selection are possible as will be apparent to those skilled in the art.

The web browser 200 further provides for the definition of a modification of the selected web page element 206. For example, the web browser 200 can provide an ‘edit’ mode of operation in which a user is able to add, remove or modify web page elements, resources or attributes of elements or resources. All such modifications are recorded by the web browser 200.

Subsequently, at step 604, the web browser 200 communicates the modification of the modified web page element 206 to the modification server 214 where the web page element modification is stored as a modification instruction 310 at step 606. It will be appreciated by those skilled in the art that the web browser 200 may alternatively be operable to directly generate and store the modification instruction 310 at the modification server 214. Further, such selection and modification facilities may be provided by the functional component 202.

FIG. 6b is a component diagram illustrating a modification instruction generator 616 in accordance with an alternative embodiment of the present invention. The alternative embodiment of FIG. 6b is operable in place of, in addition to, or in conjunction with the arrangement of FIG. 6a. The modification generator 616 is a software and/or hardware component operable to generate modification instructions 618 based on input parameters. The input parameters include any or all of an identification of a web page element 206, a user characterisation profile 612 and a timestamp 614. The user characterisation profile 612 is a profile of a user or a class of user for which one or more modification instructions 618 are generated for an identified web page element 206. The timestamp 614 is an indication of a time or time period for which the modification generator 616 generates the modification instructions 618. In use, the modification generator 616 uses or refers to rules to generate modification instructions 618 based on the input parameters. The definition of such rules are well known to those skilled in the art.

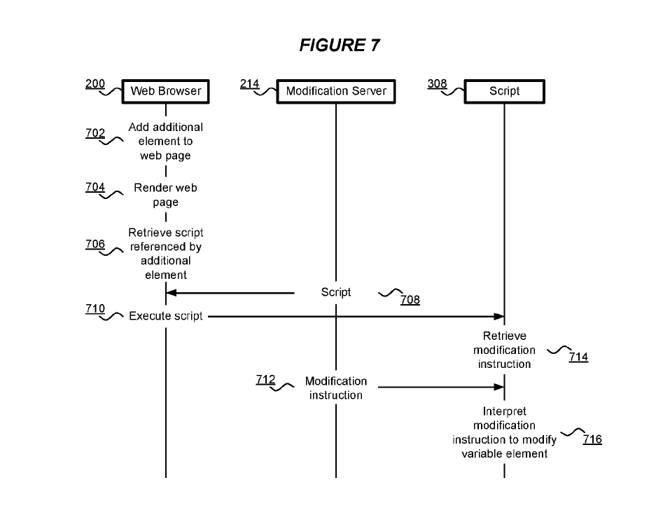

FIG. 7 is a state diagram illustrating a preferred embodiment of the present invention in operation for previewing a variant of a web page 204. At step 702 the functional component 202 adds the additional element 210, such as script tag 330, to the web page 204. At step 704 the web browser 200 renders the web page 704 using the renderer 316. At steps 706 and 708 the script 308 is retrieved by the web browser 200 from the modification server 214. At step 710 the script is executed by the web browser. Execution of the script includes the retrieval of the modification instruction 310 at step 714 from the modification server 214 at steps 712 and 714. Finally, the script 308 interprets the modification instruction 308 to modify the variable element 206c.

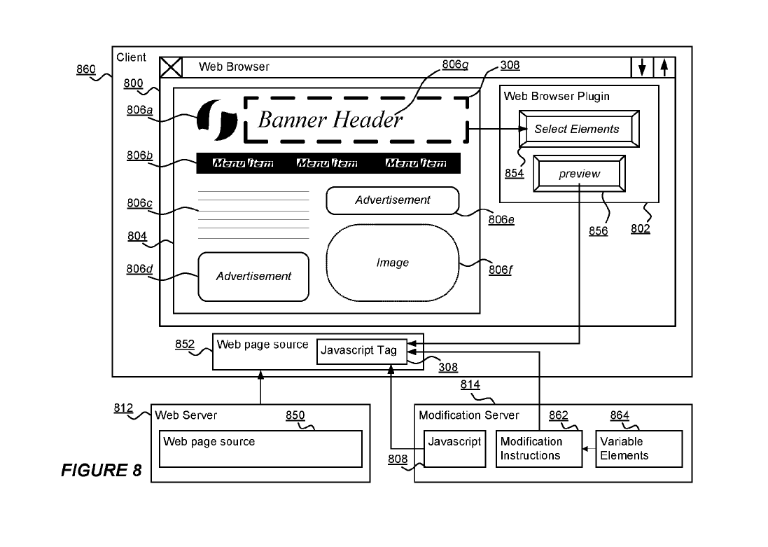

FIG. 8 is a component diagram illustrating an arrangement of a web browser 800 in accordance with an exemplary embodiment of the present invention in use. Many of the features of FIG. 8 are identical to those described above with respect to FIGS. 2 to 7 and these will not be repeated here. A client 860, such as a client computer system, is operable in communication with a web server 812 and a modification server 814. The client executes a web browser 800 for rendering a web page 804 based on web page source 852 originally communicated as web page source 850 by the web server 812.

The web page 804 includes web page elements 806a to 806g including: logo 806a; menu 806b; text 806c; advertisement content 806d; advertisement content 806e; image 806f; and banner header 806g.

The modification server 814 stores: executable JavaScript 808; and modification instructions 862 associated with variable elements 864. The variable elements 864 stored in the modification server 814 correspond to one or more of the web page elements 806a to 806g.

The web browser 804 further includes a web browser plugin 802 which is a functional component extending the functionality of the web browser 804. In an alternative embodiment, the functionality of the web browser plugin 802 can constitute an integral part of the web browser 800. The web browser plugin 802 provides and undertakes substantially all the functions of the functional component described hereinbefore. The web browser plugin 802 further provides a ‘select elements’ option 854 and a ‘preview’ option 856. In use, a user chooses the ‘select elements’ option to execute an element selection facility as described hereinbefore. Using the element selection facility, the user chooses the banner header web page element 806g for variation. The selection of the banner header web page element 806g is indicated by the broken box 308 as an illustrative mechanism for selecting one of the web page elements 806a to 806g. Modification instructions 862 are generated for the selected web page element 806g, such as by way of the mechanisms described above with respect to FIGS. 6a and 6b.

Subsequently, the user selects the ‘preview’ option 856 of the web browser plugin 802. The ‘preview’ option 856 is operable to render a variation of the web page 804 with modifications to variable elements 864 in accordance with the generated modification instructions 862. Accordingly, the ‘preview’ option 856 results in the addition of a JavaScript tag 308 to the web page source 852 stored at the client 806, the JavaScript tag 308 referring to JavaScript 808 stored at the modification server 814. Subsequently, the web browser 800 renders the web page source 852 with the additional JavaScript tag 308 to effect a modification of the banner header 806g in accordance with the generated modification instructions 862.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for defining, at a web browser, an element of a web page for variation, the method comprising the steps of:
the browser providing an element selection facility for a user to select an element for variation as a variable element;
in response to an element selection, the browser storing an identifier of the variable element;
the browser rendering a variant of the web page by adding at least one additional element to the web page so as to render the web page with a variation of the variable element.

2. The method of claim 1 wherein the variable element identifier is stored at a server computer system.

3. The method of claim 1 wherein the at least one additional element is a reference to an executable script stored at a server computer system and being suitable for execution by the web browser.

4. The method of claim 3 wherein the script is operable to perform a method including the steps of:
retrieving at least one modification instruction from the server computer system, wherein the at least one modification instruction defines a modification of the variable element; and
modifying the variable element in accordance with the one or more modification instructions so as to render a variant of the variable element.

5. The method of claim 4 wherein the one or more modification instructions are determined by a modification generator based on a characterisation of a user of the web browser.

6. The method of claim 4 wherein a modification of the variable element includes one or more of:
an addition of a resource to the variable element;
a removal of a resource from the variable element;
a specification of a size of the variable element;
a specification of a size of a resource associated with the variable element;
a specification of a location of the variable element;
a specification of a location of a resource associated with the variable element;
a specification of one or more resources for rendering with the variable element;
a visibility state of the variable element; and
specifying one or more attributes of the variable element.

7. The method of claim 6 wherein the addition of a resource, removal of a resource and specification of one or more resources include references to at least one resource stored at the server computer system.

8. The method of claim 1 wherein the steps of identifying, providing, storing and rendering are undertaken by a browser extension.

9. The method of claim 1 further comprising the steps of:
the browser accepting a user input specifying a modification to the selected element of the web page; and
storing the specified modification as a modification instruction at a server computer system.

10. Web page variation definition apparatus for defining, at a web browser, an element of a web page for variation, the apparatus comprising:
an element selector for a user to select an element for variation as a variable element;
a storer for storing an identifier of the variable element;
a renderer for rendering a variant of the web page by adding at least one additional element to the web page so as to render the web page with a variation of the variable element.

11. The apparatus of claim 10 wherein the at least one additional element is a reference to a component at a server computer system, the component comprising:
a retriever for retrieving at least one modification instruction from the server computer system, wherein the at least one modification instruction defines a modification of the variable element; and
a modifier for modifying the variable element in accordance with the one or more modification instructions so as to render a variant of the variable element.

12. The apparatus of claim 11 wherein the one or more modification instructions are determined by a modification generator based on a characterisation of a user of the web browser.

13. The apparatus of claim 10 further comprising:
a user input acceptor for accepting a user input specifying a modification to the selected element of the web page; and
a further storer for storing the specified modification as a modification instruction at a server computer system.

14. A computer program element comprising computer program code to, when loaded into a computer system and executed thereon, cause the computer to perform the steps of a method as claimed in any of claims 1 to 9.
